(19) United States
(12) Patent Application Publication
(10) Pub. No.: US 2020/0258405 A1
(43) Pub. Date: Aug. 13, 2020

(54) DETECT AND AVOID INTEGRATION WITH CONTROLLER PILOT DATA LINK COMMUNICATIONS (CPDLC)

(71) Applicant: Honeywell International Inc., Morris Plains, NJ (US)

(72) Inventors: Lisa Fern, Seattle, WA (US); Ruy C. Brandao, Redmond, WA (US)

(21) Appl. No.: 16/270,657

(22) Filed: Feb. 8, 2019

(51) Int. Cl. G08G 5/04; G08G 5/00

(52) U.S. Cl. CPC G08G 5/045; G08G 5/0026; G08G 5/0013

(57) ABSTRACT

A system and techniques for automatically generating messages to advise air traffic control (ATC) when an aircraft should maneuver based on information from the aircraft guidance system. The techniques of this disclosure integrate guidance processing algorithms, such as those found in detect and avoid (DAA) systems, with data link communications, such as those in controller pilot data link communications (CPDLC), to communicate deviations from an approved flight plan to ATC. As one example, if an aircraft collision avoidance system determines that an aircraft should deviate from the aircraft's current flight path to avoid a hazard, the techniques of this disclosure include automatically generating a message, then sending the message to ATC. In some examples, the pilot may approve the message before allowing the system to send the message to ATC. The pilot may be on board a manned aircraft or a remote pilot of an unmanned aircraft system (UAS).

### TECHNICAL FIELD

The disclosure relates to aviation communication and safety systems.

### BACKGROUND

Safe operation of manned and unmanned aircraft systems (UAS) operating together includes the use of automated and non-automated systems to avoid collision both while in flight and during ground operations. One such system is the detect and avoid (DAA) system which includes a variety of airborne and/or ground-based sensors, databases, protocols and computer systems. DAA systems help a remote operator or pilot ofa UAS to limit the risk to the UAS from hazards such as conflicting traffic, terrain and other obstacles, hazardous weather and similar hazards to aircraft. Another system, controller pilot data link communications (CPDLC) is a means of communication between an air traffic control (ATC) and pilot, using data link for ATC communications. CPDLC provides air-ground data communication as an alternative to voice communications including the ability for ATC to issue clearances, assign radio frequencies, request information and for pilots to respond. CPDLC may be used for enroute portions of flight, such as transoceanic, as well as during terminal area operations near an airport. CPDLC may be used beyond the range of UHF or VHF voice communication. Previous versions of CPDLC were called Future Air Navigation Systems (FANS).

### SUMMARY

In general, this disclosure is directed to techniques for automatically generating messages to advise ATC when an aircraft should maneuver based on information from the aircraft guidance system. The techniques of this disclosure integrate the guidance processing algorithms, such as those found in DAA, with data link communications, such as those in CPDLC, to communicate deviations from an approved flight plan to ATC. As one example, if an aircraft collision avoidance system determines that an aircraft should deviate from the aircraft's current flight path to avoid a hazard, the techniques of this disclosure include automatically generating a message, then sending the message to ATC. In some examples, the pilot may approve the message before allowing the system to send the message to ATC. The pilot may be on board a manned aircraft or a remote operator or pilot of a UAS.

In one example, the disclosure is directed to a method that includes detecting, by processing circuitry, a potential obstacle to an aircraft, wherein the processing circuitry is operatively coupled to one or more sensors and/or one or more databases; determining, that the potential obstacle requires a maneuver to avoid interference with the potential obstacle. In response to determining that the potential obstacle requires a maneuver to avoid the interference with the potential obstacle, selecting, by the processing circuitry, an avoidance maneuver to avoid the potential obstacle; generating a message to ATC describing the maneuver; transferring, by the processing circuitry, the generated message to a communication system; and sending, by the processing circuitry, the message to ATC via the communication system.

In another example, the disclosure is directed to system that includes an aircraft; processing circuitry; a guidance processing unit operatively coupled to the processing circuitry; a communications unit operatively coupled to the processing circuitry, wherein the communications unit is configured to exchange data messages with air traffic control (ATC). The processing circuitry configured to: receive a signal from the guidance processing unit; determine that the aircraft should deviate from a flight plan, based on the input signal from the guidance processing unit; select a maneuver to deviate from the flight plan; generate a message to ATC describing the maneuver; transfer the generated message to the communication unit; send the message to ATC via the communication unit.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is an illustration of an example implementation of a system to automatically generate a message to ATC to deviate from a flight plan.

FIG. 2 is a block diagram illustrating an example system to determine a maneuver to deviate from a flight plan and communicate the deviation to ATC.

FIG. 3 is a flowchart illustrating an example operation of a system to automatically generate a message to ATC to deviate from a flight plan.

### DETAILED DESCRIPTION

This disclosure is directed to techniques for automatically generating messages to advise air traffic control (ATC) when an aircraft should maneuver based on information from the aircraft guidance system. The techniques of this disclosure integrate the guidance processing algorithms, such as those found in detect and avoid (DAA) systems for DAA remain well clear (RWC) requirements and collision avoidance (CA), with the data link communications, such as those in controller pilot data link communications (CPDLC) system, to communicate deviations from an approved flight plan to ATC. As one example, if an aircraft collision avoidance system determines that an aircraft should deviate from the aircraft's current flight path to avoid a hazard, the techniques of this disclosure include automatically generating a message to ATC.

An aircraft guidance system generates both urgent maneuver guidance and non-urgent maneuver guidance alerts. Aircraft collision avoidance systems, such as terrain avoidance warning systems (TAWS) and traffic collision avoidance systems [e.g., the Traffic Alert and Collision Avoidance System (TCAS) and the Airborne Collision Avoidance System (ACAS) use inputs from various sensors to predict if an aircraft is at risk of approaching too close to a hazard, such as another aircraft. Collision avoidance systems may issue a non-urgent alert with sufficient time for the pilot to consider a response, request a deviation from ATC and receive clearance to deviate. A deviation maneuver may include climbing, descending, or changing course or speed. In the example where a collision is imminent, the collision avoidance system may generate an urgent maneuver alert and the pilot is required, when able, notify ATC after the aircraft deviates from the approved flight path.

In other examples, a guidance processing algorithm may receive an indication of an issue with the aircraft, such as a partial power loss, flight control surface malfunction, or similar issue. The aircraft may need to maneuver to respond to the issue, for example a partial power loss in a climb, such as loss of an engine in a multi-engine aircraft, may require the aircraft to deviate from the assigned climb trajectory and speed in response to the partial power loss. The need to maneuver to respond to an aircraft issue may be urgent or non-urgent.

Currently, for both manned aircraft and UAS a human operator or pilot is required to be in the approval loop to execute maneuvers in compliance with see and avoid requirements in part 91.113 of the Code of Federal Regulations (14 CFR 91.113). UAS are required to equip with a DAA system including an alerting and guidance algorithm that provides a range of safe maneuver options provided by the aircraft guidance system, that the UAS pilot selects from. While not required, manned aircraft may in some instances also include a DAA algorithm or similar system that provides a range of safe maneuver options to the pilot. For aircraft operating according to Instrument Flight Rules (IFR), the pilot must then coordinate the ATC clearance via VHF or UHF voice communications and execute that maneuver. For a manned aircraft, the pilot may execute the maneuver by operating the flight controls or selecting a maneuver to be executed by the aircraft guidance system. For a UAS, the remote operator or pilot may command the UAS aircraft to execute the maneuver via the ground control station navigation interface.

In this disclosure, for example with a UAS, the DAA guidance processing algorithm for the UAS may calculate a directive maneuver for a corrective alert (non-urgent). The UAS systems may automatically generate an ATC clearance request and send to ATC via an interface with CPDLC. Upon receipt of ATC approval, the aircraft systems can execute the directive maneuver. In some examples, the pilot may approve the message before allowing the system to send the message to ATC. For a directive maneuver calculated by the guidance processing algorithm during a warning alert (urgent), the UAS systems may execute the maneuver to avoid the hazard, then automatically generate an ATC notification and send to ATC via CPDLC.

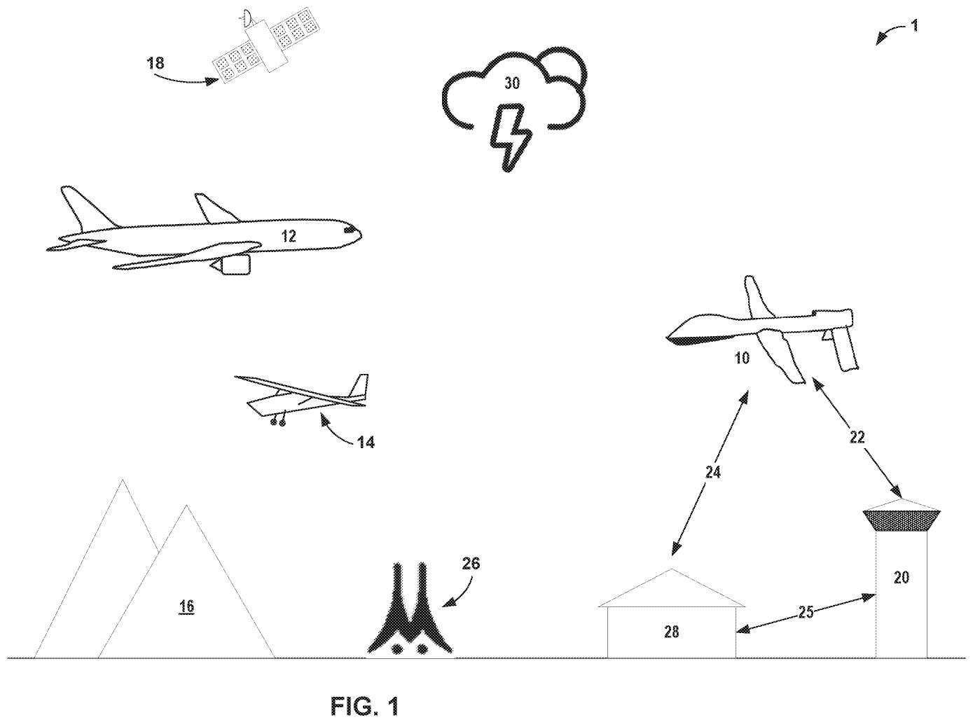

FIG. 1 is an illustration of an example implementation of a system to automatically generate a message to ATC to deviate from a flight plan. The example of system 1 includes air, space and ground-based systems operating in the same environment as well as airborne and ground obstacles that may impact operations.

Airborne systems include unmanned aircraft, such as UAS 10, and pilot operated aircraft such as aircraft 12 and aircraft 14. In some examples, aircraft 12 may include large commercial aircraft that may be equipped with a suite of sensors, communication equipment, a flight management system (FMS), and other equipment. Some examples of airborne sensors that may be aboard aircraft 12, UAS 10 or other airborne platforms may include radar such as weather radar, ground avoidance radar, radar altimeter, and other active sensors. Passive sensors may include thermometer, pressure sensors, optical sensors such as cameras, including infrared cameras, and similar passive sensors. In some examples, aircraft may include automatic dependent surveillance-broadcast (ADS-B) interrogation and transponder capability (e.g. ADS-B-In and ADS-B-Out), which may provide weather, traffic and collision avoidance information. Aircraft 12 and aircraft 14 may communicate with ATC 20 via voice radio or text based systems such as CPDLC.

Aircraft 14 may include aircraft that are smaller and less well equipped such as general aviation aircraft, helicopters, balloons, airships and similar aircraft. In some examples aircraft 14 may not include a communication radio, a transponder or ADS-B equipment.

Unmanned aircraft, such as UAS 10 may include fixed and rotary wing UAS operated by a remote vehicle operator. In some examples UAS 10 may communicate with ground station 28 to receive commands and provide information, e.g. via communication link 24. In some examples the remote vehicle operator may be present at ground station 28. In other examples, the remote vehicle operator may be at a different location but linked to ground station 28 via satellite, ground-based or other communication means. In some examples, UAS 10 may communicate directly with ATC 20 via communication link 22. In other examples UAS 10 may send information and requests to ATC 20, as well as receive instructions from ATC 20 indirectly via communication link 25 through ground station 28.

Satellite 18 may provide communication links, and navigation functions, such as global positioning system (GPS). Satellite 18 may also provide sensing functions, such as imagery including radar and optical imagery and other sensing functions.

System 1 may include ground based sensors included in ground station 28, ATC 20 or separate sensors not shown in FIG. 1. Some examples of ground based sensors may include short and long range radar, optical sensors, direction finding and altitude sensing equipment, and weather sensors. Some examples of weather sensors include the Automated Weather Observing System (AWOS) and the Automated Surface Observing System (ASOS). Ground based sensors may also include ADS-B ground stations that receive and transmit information to and from aircraft such as UAS 10, aircraft 12 and aircraft 14.

Some examples of obstacles that may impact operations may include natural terrain, man-made terrain and hazardous weather. Natural terrain may include mountains 16, as trees and similar natural objects in the vicinity of aircraft operations (not shown in FIG. 1). Other natural obstacles may include wildlife in the area of ground operations, birds, bats flying near aircraft, as well as blowing dust, volcanic ash and similar natural obstacles (not shown in FIG. 1). Hazardous weather may include thunderstorms 30, clear air turbulence, low level wind shear, mountain waves, and other weather phenomena (not shown in FIG. 1).

Man-made terrain may include towers 26, cranes, buildings, electrical transmission wires, ground vehicles operating near runways and similar obstacles (not shown in FIG. 1). Other artificial obstacles may include boundaries established by regulations or because of certain events. For example, certain wildlife refuges may have a restriction on whether aircraft may fly over the wildlife refuge below a predetermined altitude. Similarly, a temporary flight restriction (TFR), geofence or other restriction may restrict aircraft operation near a large gathering of people, such as a sporting event, near a disaster area where rescue aircraft may be operating, such as a wildfire, or near other areas such as near a nuclear power plant.

In operation, one or more air or ground based sensors may detect a potential obstacle to an aircraft. As discussed above, the potential obstacle may include terrain, a flight restriction area, weather, or another aircraft. The one or more sensors may be operatively coupled to processing circuitry on board an aircraft as well as at a ground location such as ATC 20 and ground station 28. The processing circuitry may be further coupled to memory locations that include one or more databases, as well as programming instructions that may be executed by the processing circuitry. In other examples, processing circuitry may request a deviation from an approved flight path because a different route may be just a better route, e.g. better weather, better visibility for an electro-optical (EO) sensor, less transit time, reduced fuel burn, or for other similar reasons.

The processing circuitry, either airborne or ground based, may determine that the potential obstacle requires a maneuver to avoid interference with the potential obstacle. For example, processing circuitry may determine that, based on the direction and speed of aircraft 12, and the movement of thunderstorm 30, that aircraft 12 should deviate from an approved flight plan provided to aircraft 12 by ATC 20. Because a thunderstorm can generate dangerous winds up to 20 nautical miles (NM) away, the processing circuitry may determine that aircraft 12 should deviate from the approved flight plan though aircraft 12 may not necessarily collide with or pass through thunderstorm 30. In the example of weather avoidance, processing circuitry may generate a non-urgent alert based on rules in the one or more databases and programming instructions.

In other examples, processing circuitry that may be part of a collision avoidance system may use inputs from various sensors to predict if an aircraft is at risk of approaching too close to an obstacle, such as another aircraft. In other words, the collision avoidance system may predict a flight path intersection with the flight path of another aircraft. For example, UAS 10 may be at risk of approaching too close to aircraft 14. The processing circuitry may determine the degree and urgency of risk by comparing the predicted position of UAS 10 and aircraft 14 to rules, such as the RWC requirements or other rules that may be included in the one or more databases and programming instructions. Depending on the degree and urgency of risk, the processing circuitry may issue either an urgent maneuver guidance or a non-urgent maneuver guidance alert.

In other examples, processing circuitry operatively coupled to a database, such as a terrain database, may determine a maneuver is required based on the database. The database may be on the ground, e.g. at ground station 28 or another location, or in the air, e.g. at a computer readable storage medium on board UAS 10. In other examples processing circuitry may determine a maneuver is required based on some combination of sensors, databases and programming instructions. For example, a navigational sensor onboard UAS 10, such as a GPS sensor or an inertial navigation system, may determine the position of UAS 10 relative to mountains 16 by consulting the terrain database. Additional sensors, such as TCAS, may determine the predicted relative position of UAS 10 to aircraft 14. Based on both the sensors and the information from the terrain database, the processing circuitry may determine a maneuver that avoids interference with both the terrain, as well as aircraft 14.

In response to determining that the potential obstacle requires a maneuver to avoid the collision with the potential obstacle, the processing circuitry may select an avoidance maneuver to avoid the potential obstacle. As described above, the selected avoidance maneuver may include a change of course, speed, altitude or other maneuver. The processing circuitry may automatically generate a message to ATC 20 describing the avoidance maneuver. In the example of a non-urgent situation, the automatically generated message may be a request to ATC 20 to deviate from an existing flight clearance. The processing circuitry may transfer the generated message to a communication system and send the message to ATC 20 via the communication system.

In some examples, the processing circuitry may require an approval from the vehicle operator before sending the message to ATC 20. The processing circuitry may alert the user that a pending message to ATC 20 is waiting for approval. The alert may be a visual indication, such as on a multi-function display (MFD), an auditory alert or some other type of alert. The vehicle operator may be a pilot, such as a pilot of aircraft 12, or a remote pilot, which may receive the alert at ground station 28. The vehicle operator may consider the automatically generated message and approve or reject the message, for example via a user input device. In response to receiving the approval the processing circuitry may send the message to ATC 20 via the communication system.

The processing circuitry may subsequently receive approval from ATC to execute the requested maneuver. In some examples, the processing circuitry may decompose the selected maneuver into a sequence of actions and send the sequence of actions to an autopilot of the aircraft. In some examples, the sequence of actions may require approval from the vehicle operator before the sequence is loaded into the autopilot or before the sequence is executed by the autopilot. In some examples, the processing circuitry that generates and receives the communication to and from ATC may be different from processing circuitry that determines the sequence of actions to execute the maneuver and sends the sequence to the autopilot.

In other examples, ATC may disapprove the requested maneuver for a variety of reasons. In some examples ATC may instruct the aircraft to execute a different maneuver. In other examples, the processing circuitry may receive the disapproval message from ATC and select a different maneuver to avoid interference with the obstacle. The processing circuitry may generate and send a second request to ATC to execute the different maneuver. As described above, sending the second request may require approval from a vehicle operator.

In this manner, the techniques of this disclosure may improve efficiency, reduce pilot workload, improve accuracy of communication and reduce the bandwidth usage of voice communication. Approving an automatically generated message reduces the workload for a vehicle operator when compared to the operator determining the maneuver and composing a request to ATC. Further, some portions of flight path clearances and ATC clearances need to be spelled out phonetically and repeated back. Automatically generating and sending text based messages may reduce the amount of time required to request and deliver a clearance. For example, ATC procedure may require an air traffic controller to deliver a clearance such as, “deviation approved, climb and maintain 3000, proceed to RIPON, Romeo-India-Papa-Oscar-November.” In contrast, a text based message is already spelled out and therefore may require less time consumed over a voice radio.

The example of system in which the vehicle operator, or pilot, does not need to approve the automatically generated message before sending to ATC may provide additional advantages over other systems. In some examples, UAS vehicle operators may be controlling multiple UAS vehicles. Reduced workload, especially for operators of multiple vehicles, may be desirable in some examples. The disclosed system, which may determine that a vehicle should execute a maneuver, for example to avoid interference with a potential obstacle, reduce fuel consumption or for other reasons, then generate and send a message to ATC describing the maneuver may reduce operator workload and improve safety. In some examples, the system may generate and send the message to ATC while informing the vehicle operator. The vehicle operator may override the automatically generated message and maneuver if needed. An automatically generated and sent message, along with the ability to receive an ATC approval to execute the maneuver, decompose the selected maneuver into a sequence of actions, send the sequence of actions to an autopilot unit of the aircraft may reduce delay in executing the maneuver. A reduced delay may prevent a caution situation from becoming an urgent and dangerous situation. Additional benefits may include enabling higher levels of automation and autonomous operations and reducing skill and training requirements for operators, such as for simplified vehicle operations (SVO).

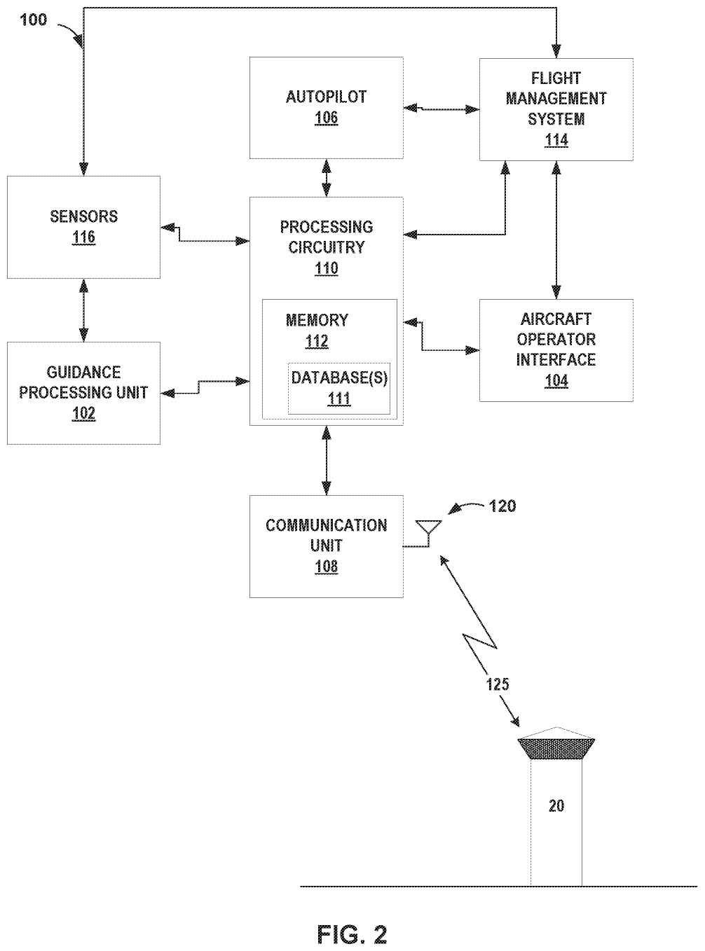

FIG. 2 is a block diagram illustrating an example system to determine a maneuver to deviate from a flight plan and communicate the deviation to ATC. System 100 is an example of system 1 described above in relation to FIG. 1. Some components of system 100 may be airborne, i.e. installed on the aircraft. In some examples, some components of system 100 may also be ground based, e.g. installed at ground station 28 depicted in FIG. 1 or be implemented as some combination of both airborne and ground based. To simplify the description, system 100 will be described in terms of UAS 10, though system 100 may be implemented by any of aircraft 12, aircraft 14 and UAS 10 depicted in FIG. 1.

Example system 100 depicted in FIG. 2 includes processing circuitry 110, which is operatively connected to memory unit 112 as swell as guidance processing unit 102, autopilot 106, FMS 114, aircraft operator interface 104, sensors 116 and communication unit 108. In the example of system 100, processing circuitry 110 communicates to ATC 20 via communication unit 108 and antenna 120. As described above, processing circuitry 110 may be implemented as some combination of an airborne and ground based computing system, and therefore ground station 28 is not shown in FIG. 2. Communication link 22 and communication link 25 described above in relation to FIG. 1 may be assumed to be part of communication link 125. The example of system 100 is arranged as one implementation of a system of this disclosure. In other examples, the components of system may be arranged in a variety of ways, e.g. guidance processing unit 102 and autopilot 106 may be considered a single unit, FMS 114 may be broken into several other components, or there may be additional components not shown in FIG. 2. In some examples FMS 114 may include Air Traffic Management (ATM) functionality as well as navigation information to reduce pilot workload such as vectors-to-final approaches, enroute holding procedures, and similar functions.

Examples of processing circuitry 110 may include any one or more of a microcontroller (MCU), e.g. a computer on a single integrated circuit containing a processor core, memory, and programmable input/output peripherals, a microprocessor (pP), e.g. a central processing unit (CPU) on a single integrated circuit (IC), a controller, a digital signal processor (DSP), an application specific integrated circuit (ASIC), a field-programmable gate array (FPGA), a system on chip (SoC) or equivalent discrete or integrated logic circuitry. A processor may be integrated circuitry, i.e., integrated processing circuitry, and that the integrated processing circuitry may be realized as fixed hardware processing circuitry, programmable processing circuitry and/or a combination of both fixed and programmable processing circuitry. Though not described in detail, other components of system 100 may also include separate processing circuitry. For example, guidance processing unit 102, autopilot 106, and FMS 114 may also include one or more processors. Some examples of sensors 116, such as weather radar, may also include one or more processors.

Memory unit 112 may comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. In other words, memory unit 112 is a computer readable storage medium operatively coupled to processing circuitry 110, and other processing circuitry that may be included in other components of system 100. Though memory unit 112 is shown as a single unit in the example of system 100, memory unit 112, as well as processing circuitry 110, may be spread across multiple locations, both airborne and ground based. For example, portions of memory unit 112 may be installed in UAS 10, while other portions of memory unit 112 may be installed at ground station 28 described above in relation to FIG. 1. Still other portions of memory unit 112 may be installed in other locations separate from ground station 28 and operatively connected such that various portions of processing circuitry 110 may access the programming instructions, databases, such as databases 111, data and other information at memory unit 112.

Examples of databases 111 may include terrain contour databases, such as may be mapped by LIDAR (Light Detection and Ranging) systems, airspace, airport approach and departure procedures, navigation features and waypoints, weather information, and similar databases. As described above, databases 111 may be on board an aircraft, such as UAS 10 or aircraft 12, depicted in FIG. 1. In other examples, databases 111 may be located at ground based computing devices, such as computing devices in one or more ground stations 28, ATC 20 or other locations, and accessed via communication links 22 and 24.

Sensors 116 may include space, airborne and ground based sensors as described above in relation to FIG. 1. To simplify the explanation of FIG. 2, sensors 116 is shown as a single block. In some examples, ground based sensors may communicate information to guidance processing unit 102 and processing circuitry 110 via communication link 125. Some examples of signals from sensors 116 may include location, course and speed of UAS 10 from inertial navigation systems and GPS, air pressure, air temperature, engine performance, fuel capacity remaining, distance above mean sea level (MSL), distance above ground level (AGL), weather information, traffic location, course speed and predicted path, and similar information. In some examples, information from sensors 116, such as engine performance and navigation information, may also be sent to FMS 114. Sensors 116 may also receive commands from guidance processing unit 102, processing circuitry 110 and FMS 114 to collect certain information, change sensor settings and other commands.

Guidance processing unit 102 may receive signals from sensors 116 and processing circuitry within guidance processing unit 102 may evaluate the current flight path of UAS 10 in comparison to other information received from sensors 116. In some examples, guidance processing unit 102 may send a signal to processing circuitry 110. In some examples, guidance processing unit 102 may be a part of a guidance processing unit is a component of a DAA system. Based on the signal from guidance processing unit 102, processing circuitry 110 may determine that UAS 10 should deviate from the current flight plan. In other examples, processing circuitry within guidance processing unit 102 may determine that UAS 10 should deviate from the current flight plan and communicate the determination to processing circuitry 110.

Processing circuitry 110 may select a maneuver to deviate from the flight plan. In some examples, the selected maneuver may depend on the signals from guidance processing unit 102 and sensors 116. For example, processing circuitry 110 may select a course change maneuver rather than a climbing maneuver based on fuel remaining, engine performance and location of UAS 10 in relation to terrain in the area in which UAS 10 is operating, according to the rules in the databases and programming instructions at memory unit 112.

Processing circuitry 110 may automatically generate a message to ATC 20 describing the maneuver and transfer the generated message to communication unit 108. In some examples, as described above in relation to FIG. 1, processing circuitry 110 may cause communication unit 108 to send the generated message to ATC 20 via antenna 120 and communication link 125. In other examples, processing circuitry 110 may display an indication that the message to ATC 20 has been generated and wait for approval from a human operator of UAS 10. Processing circuitry 110 may cause the indication of the generated message to be displayed, for example, at aircraft operator interface 104. Aircraft operator interface 104 may include one or more visual devices, such as display screens and indicator lights, one or more auditory alert devices and one or more input devices such as keyboard, touch screen or similar input devices. In some examples, aircraft operator interface 104 may also simultaneously display traffic in addition to terrain, airspace, airways, airports and navigation aids. After the human operator reviews and approves the generated message, processing circuitry 110 may cause communication unit 108 to send the generated message to ATC 20. In some examples, whether processing circuitry 110 must wait for approval before sending the generated message may depend on whether the maneuver is based on an urgent maneuver guidance or a non-urgent maneuver guidance alert.

In some examples, for a directive maneuver calculated by a guidance processing algorithm executed by guidance processing unit 102 during a warning alert, UAS 10 may execute the maneuver to avoid the hazard, then automatically generate an ATC notification and send to ATC 20 via communication unit 108, for example by using CPDLC. As one example, processing circuitry may receive an indication of an aircraft malfunction and select the maneuver to deviate from the flight plan based on both the indication of the aircraft malfunction and the input signal from guidance processing unit 102. In other examples, processing circuitry 110 controlling UAS 10 may have determined a risk of collision with another aircraft existed and sent a non-urgent message describing the maneuver as a request to deviate from an existing flight clearance but did not receive a timely response from ATC 20. Processing circuitry 110 may determine the risk of collision is now urgent, cause UAS 10 to execute a maneuver, generate and send a message describing the maneuver as a notification of a deviation from the existing flight clearance.

In other examples, processing circuitry 110 may receive an ATC approval to execute the requested maneuver. Processing circuitry 110 may decompose the selected maneuver into a sequence of actions and send the sequence of actions to autopilot 106 for UAS 10. In some examples, the sequence of actions may require approval from the vehicle operator via aircraft operator interface 104 before the sequence is loaded into autopilot 106 or before the sequence is executed by autopilot 106. In some examples, the guidance processing algorithm executing on guidance processing unit 102 may determine the sequence of actions to be sent to autopilot 106.

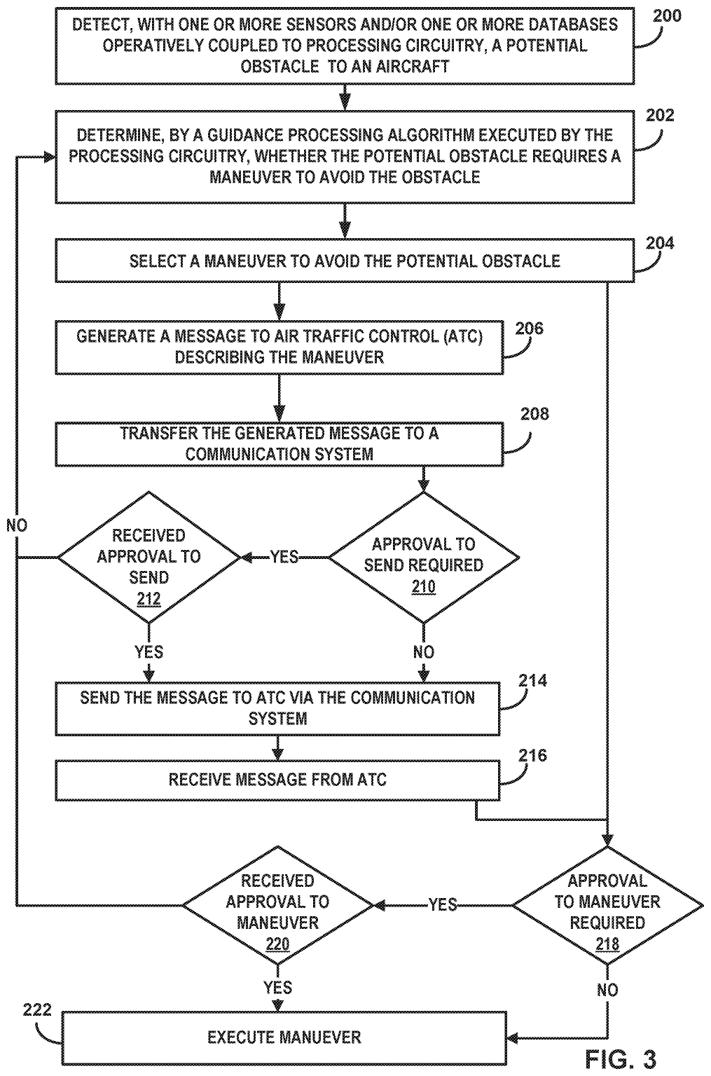

FIG. 3 is a flowchart illustrating an example operation of a system to automatically generate a message to ATC to deviate from a flight plan. The blocks of FIG. 3 will be described in terms of FIGS. 1 and 2.

A system that includes the techniques of this disclosure, such as system 1 and system 100, may detect, with one or more sensors operatively coupled to processing circuitry, a potential obstacle to an aircraft, such as UAS 10 (200). As described above in relation to FIG. 2, sensors, e.g. sensors 116 may be space, airborne or ground based.

Processing circuitry may determine whether the potential obstacle requires a maneuver to avoid the obstacle (202). In some examples a guidance processing algorithm executed by the processing circuitry, may determine UAS 10 should maneuver to avoid interference with the potential obstacle.

In response to determining that UAS 10 requires a maneuver to avoid the interference with the potential obstacle, processing circuitry, e.g. processing circuitry 110, may select an avoidance maneuver to avoid the potential obstacle (204). As described above in relation to FIGS. 1 and 2, the selected maneuver may be chosen from several different maneuver options. The choice of maneuver may depend on whether the maneuver is a directive maneuver calculated by the guidance processing algorithm during a warning alert (urgent), or a directive maneuver for a corrective alert (non-urgent).

Processing circuitry 110 may generate a message to ATC 20 describing the maneuver (206) and automatically transfer the generated message to a communication system, such as CPDLC (208). In some examples, the programming instructions for processing circuitry 110 may require a human operator to approve a generated message before sending the message to ATC 20 (YES branch of 210). Once the vehicle operator reviews and approves the generated message, e.g. via a user input device like aircraft operator interface 104 (YES branch of 212), processing circuitry 110 to cause the message to be sent to ATC 20, via e.g. CPDLC (214).

In other examples, programming instructions for processing circuitry 110 may allow processing circuitry 110 to cause the message to be sent to ATC 20 without approval (NO branch of 210 and 214). In other examples, processing circuitry 110 may not receive approval to send the generated message (NO branch of 212). In some examples, processing circuitry may further determine a different maneuver to avoid interference with the potential obstacle (202).

Communication unit 108 may receive a response message from ATC 20 via communication link 125 and antenna 120 (216). In the example of a non-urgent alert, approval to maneuver from ATC 20 is required (YES branch of 218). The message from ATC 20 may approve the deviation from the original flight clearance by sending an updated clearance (YES branch of 220).

Processing circuitry 110 may cause UAS 10 to execute the approved maneuver (222). As described above in relation to FIG. 2, processing circuitry 110 may load a sequence of actions into autopilot 106, which may cause UAS 10 to execute the approved maneuver.

In some examples, ATC may disapprove the requested maneuver (NO branch of 220). In some examples ATC may instruct the aircraft to execute a different maneuver, such as a climbing turn instead of a climb. In other examples, the processing circuitry may receive the disapproval message from ATC and select a different maneuver to avoid interference with the obstacle (202).

In one or more examples, the functions described above may be implemented in hardware, software, firmware, or any combination thereof. For example, the various components of FIG. 2, such as processing circuitry 110, and guidance processing unit 102 may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media, such as memory unit 112, can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks may reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor” and “processing circuitry” as used herein, such as processing circuitry 110, may refer to any of the foregoing structure or any other structure suitable for implementation of the techniques described herein. In addition, in some aspects, the functionality described herein may be provided within dedicated hardware and/or software modules configured for encoding and decoding. Also, the techniques could be fully implemented in one or more circuits or logic elements.

The techniques of this disclosure may be implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. These and other examples are within the scope of the following claims.

1. A method comprising:
detecting, by processing circuitry, a potential obstacle to an aircraft, wherein the processing circuitry is operatively coupled to one or more sensors and/or one or more databases;
determining, that the potential obstacle requires a maneuver to avoid interference with the potential obstacle;
in response to determining that the potential obstacle requires a maneuver to avoid the interference with the potential obstacle, selecting, by the processing circuitry, an avoidance maneuver to avoid the potential obstacle;
generating a message to air traffic control (ATC) describing the maneuver;
transferring, by the processing circuitry, the generated message to a communication system; and
sending, by the processing circuitry, the message to ATC via the communication system.

2. The method of claim 1, further comprising:
receiving, by the processing circuitry and via a user input device, an approval to send the message to ATC; and
in response to receiving the approval, sending the message to ATC via the communication system.

3. The method of claim 1, wherein the one or more sensors are selected from a group comprising: space based sensors, airborne sensors and ground based sensors.

4. The method of claim 1, wherein the processing circuitry is operatively coupled to one or more databases.

5. The method of claim 1, wherein the message describing the maneuver is a request to deviate from an existing flight clearance.

6. The method of claim 1, wherein the message describing the maneuver is a notification of a deviation from an existing flight clearance.

7. The method of claim 1, further comprising:
receiving, by the processing circuitry, an ATC approval to execute the maneuver;
decomposing, by the processing circuitry, the selected maneuver into a sequence of actions;
sending, by the processing circuitry, the sequence of actions to an autopilot of the aircraft.

8. The method of claim 1, wherein the aircraft comprises an unmanned aircraft system (UAS), and wherein the processing circuitry comprises a ground-based computing system.

9. The method of claim 1, wherein the obstacle is selected from a group comprising:
a flight path intersection with a flight path of another aircraft, natural terrain, man-made terrain; a GeoFence, and hazardous weather.

10. A system comprising:
a guidance processing unit;
a communications unit configured to exchange data messages with air traffic control (ATC);
processing circuitry operatively coupled to the guidance processing unit and the communications unit and configured to:
receive a signal from the guidance processing unit;
determine that an aircraft should deviate from a flight plan, based on the input signal from the guidance processing unit;
select a maneuver to deviate from the flight plan;
generate a message to ATC describing the maneuver;
transfer the generated message to the communication unit;
send the message to ATC via the communication unit.

11. The system of claim 10, further comprising one or more sensors operatively coupled to the guidance processing unit,
wherein the guidance processing unit is configured to:
determine a potential obstacle to the aircraft based on an indication from the one or more sensors wherein the one or more sensors are selected from a group comprising: space based sensors, airborne sensors and ground based sensors;
determine a maneuver to avoid the potential obstacle,
include the determined maneuver in the signal to the processing circuitry, and
wherein the processing circuitry is configured to select the maneuver to deviate from the flight plan based on the determined maneuver to avoid the potential obstacle.

12. The system of claim 10, wherein the guidance processing unit comprises a computer readable storage medium operatively coupled to the processing circuitry, the computer readable storage medium comprising a guidance processing algorithm executed by the processing circuitry.

13. The system of claim 12, wherein the computer readable storage medium further comprises one or more databases, wherein the guidance processing unit is configured to:
determine a potential obstacle to the aircraft based on an indication from the one or more databases;
determine a maneuver to avoid the potential obstacle, include the determined maneuver in the signal to the processing circuitry, and
wherein the processing circuitry is configured to select the maneuver to deviate from the flight plan based on the determined maneuver to avoid the potential obstacle.

14. The system of claim 10, wherein the processing circuitry is further configured to:
receive an indication of an aircraft malfunction; and
select the maneuver to deviate from the flight plan based on both the indication of the aircraft malfunction and the input signal from the guidance processing unit.

15. The system of claim 10, wherein the message describing the maneuver is a request to deviate from an existing flight clearance.

16. The system of claim 15, wherein the processing circuitry is further configured to:
receive an ATC approval to execute the maneuver;
decompose the selected maneuver into a sequence of actions;
send the sequence of actions to an autopilot unit of the aircraft.

17. The system of claim 10, wherein the message describing the maneuver is a notification of a deviation from an existing flight clearance.

18. The system of claim 10, wherein the processing circuitry is further configured to:
receive an approval to send the message to ATC; and
in response to receiving the approval, sending the message to ATC via the communication unit.

19. The system of claim 10, wherein the guidance processing unit is a component of a Detect and Avoid (DAA) system.

20. The system of claim 10, wherein the communication unit comprises a controller pilot data link communications (CPDLC) system.
